(19) United States
(12) Patent Application Publication
(10) Pub. No.: US 2026/0160644 A1
(43) Pub. Date: Jun. 11, 2026

(54) SYSTEM AND METHOD OF CONTROLLING FLUID LOCATION ON A ROAD SURFACE

(71) Applicant: Torc Robotics, Inc., Blacksburg, VA (US)

(72) Inventors: William Gray Davis, Austin, TX (US); Joseph R. Fox-Rabinovitz, Austin, TX (US)

(21) Appl. No.: 18/969,432

(22) Filed: Dec. 5, 2024

(51) Int. Cl. G01M 17/007

(52) U.S. Cl. CPC G01M 17/007

(57) ABSTRACT

A fluid testing assembly configured for use with a road. The fluid testing assembly includes a fluid source containing a fluid, wherein the fluid source is connected to a conduit and in fluid communication with a driving surface of the road. The conduit defines an outlet positioned in proximity to the driving surface of the road, wherein the fluid is delivered from the fluid source to a desired location along the driving surface through the outlet of the conduit.

### TECHNICAL FIELD

The field of the disclosure relates to conditions for testing an autonomous vehicle and, in particular, to controlling the location of a fluid on a road surface.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

The driving conditions of a vehicle are typically tested by operating the vehicle during a weather event (e.g., rain, snow, ice) or simulated by spraying a road surface with a hose or a rain tower. However, the current testing conditions are limited to the weather and/or the location of the hose or rain tower, but lack precision and adaptability. Therefore, there remains a need to provide a controlled road testing system and method.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a fluid testing assembly configured for use with a road. The fluid testing assembly includes a fluid source containing a fluid, wherein the fluid source is connected to a conduit and in fluid communication with a driving surface of the road. The conduit defines an outlet positioned in proximity to the driving surface of the road, wherein the fluid is delivered from the fluid source to a desired location along the driving surface through the outlet of the conduit.

In another aspect, a method of distributing a fluid to a driving surface of a road for testing a vehicle. The method includes directing the fluid from a fluid source to the driving surface of the road; controlling the distribution of the fluid to the driving surface at a desired location; and discharging the fluid from the driving surface.

In yet another aspect, a fluid testing assembly configured for use with a road. The fluid testing assembly includes a fluid source containing a fluid, wherein the fluid source is connected to a plurality of openings and in fluid communication with a driving surface of the road. The plurality of openings extend through the driving surface of the road and are each selectively configured to deliver the fluid to the driving surface or remove the fluid from the driving surface.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is a side schematic view of a fluid testing assembly including a road with a depression;

FIG. 5 is a top schematic view of the fluid testing assembly shown in FIG. 4 with a driving surface including depressions positioned throughout;

FIG. 6 is a top schematic view of a fluid testing assembly including a plurality of openings positioned along a driving surface of a road and a single area with a fluid;

FIG. 7 is a top schematic view of the fluid testing assembly shown in FIG. 6 including a plurality of openings positioned along the driving surface of the road and multiple areas with a fluid;

FIG. 8 is a side schematic view of the fluid testing assembly shown in FIGS. 6 and 7;

FIG. 9 is a top schematic view of a fluid testing assembly including a plurality of fluid delivery devices positioned along a driving surface of a road; and

FIG. 10 is a side schematic view of the fluid testing assembly shown in FIG. 9.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, the present disclosure is directed to systems and methods for controlling a fluid on a surface. For example, systems and methods for controlling the location and/or quantity of a fluid on a surface. In non-limiting example, the surface may refer to any surface associated with a vehicle, including public surfaces, private surfaces, and/or surfaces designed for testing a vehicle. In non-limiting examples, the surface material may be selected from a traditional surface material, including but not limited to, asphalt, concrete, stone, brick, crushed stone, pavers, grass, dirt, and combinations thereof. For example, the surface may include a road, sidewalk, parking lot, and combinations thereof. As used herein, the surface may be referred to as a road without departing from the spirit/scope of this disclosure.

The embodiments disclosed herein may be used as a system to test how a vehicle operates during various driving conditions. Roads may collect a fluid in different locations which can create challenges for operating a vehicle on said road. However, to date it has been challenging to test autonomous vehicle performance during various operating conditions where a fluid is pooled on a road surface. The embodiments described herein enable testing of various operating conditions, including for example, pooling of the fluid in specific locations on the road. The embodiments also enable testing with a variety of fluids, for example, any fluid that may be delivered by a vehicle on the road and/or carried by the vehicle, including but not limited to, oil, gas, water, water and soap, and combinations thereof.

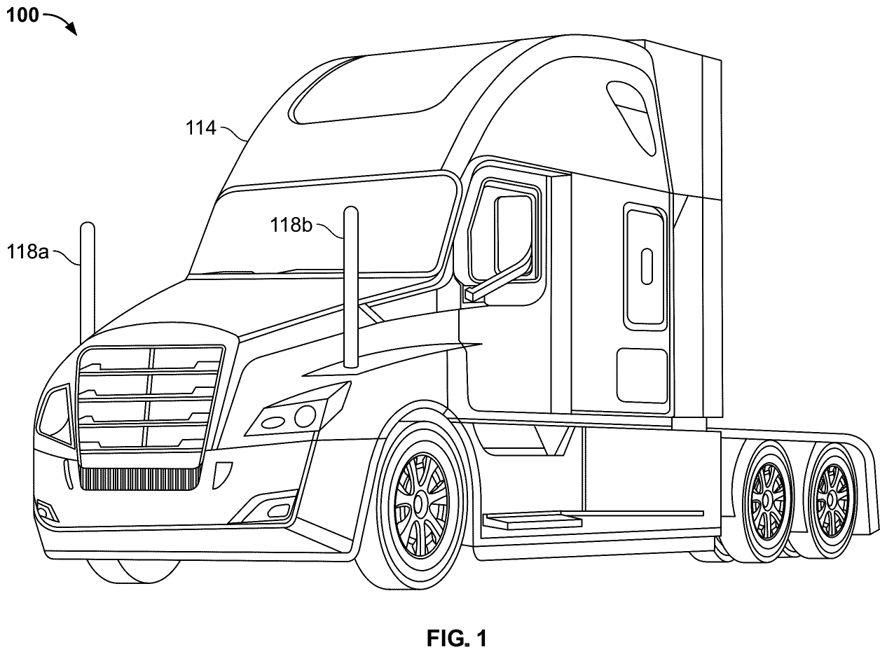

Various embodiments in the present disclosure are described with reference to FIGS. 1-10 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114. The vehicle 100 includes an antenna 118, referenced as a pair of antennas 118A, 118B, which are positioned near the front of the vehicle 100. The pair of antennas 118A, 118B may include one or more sensors.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

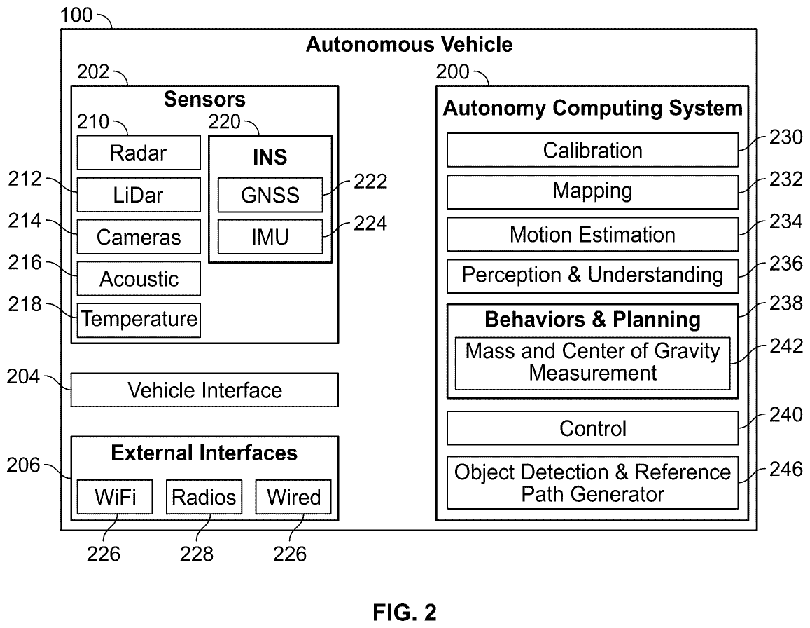

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 242. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

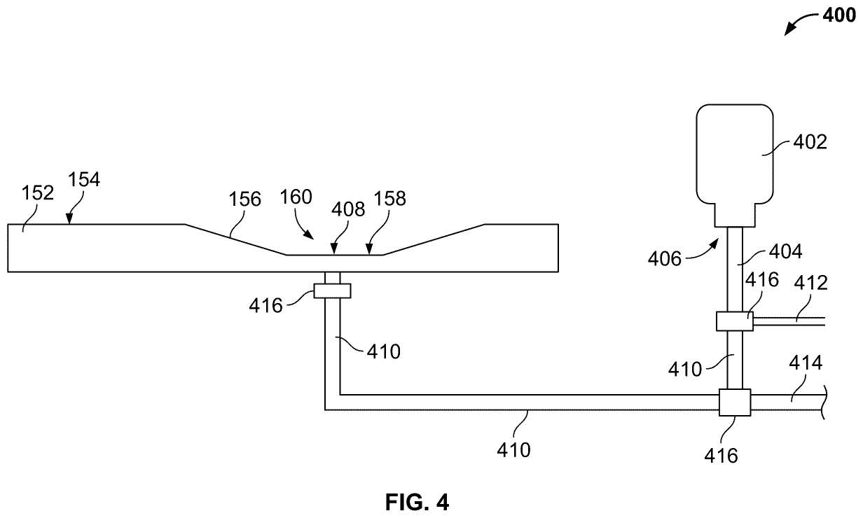

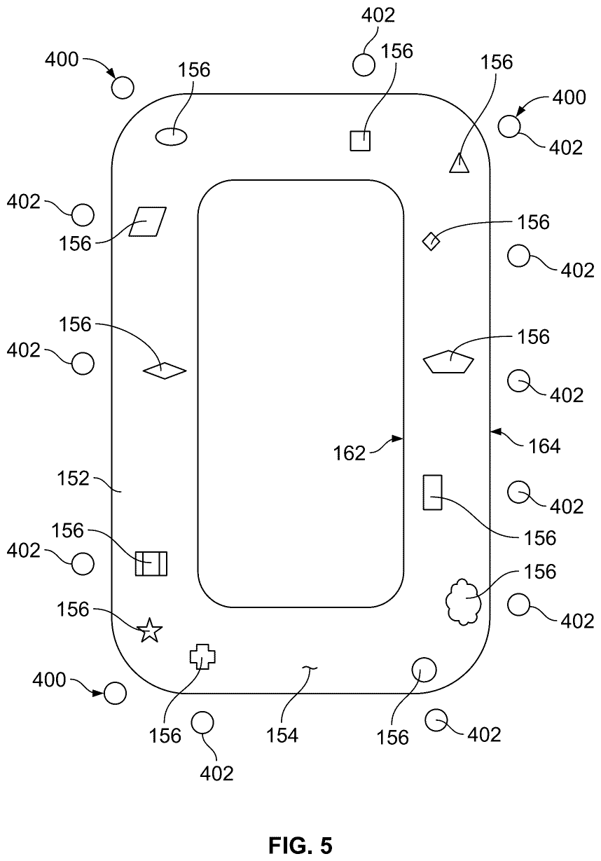

The object detection and reference path generator module 242 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both. Tasks performed by the object detection and reference path generator module 242 are described in detail using FIG. 4 and FIG. 5 below.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

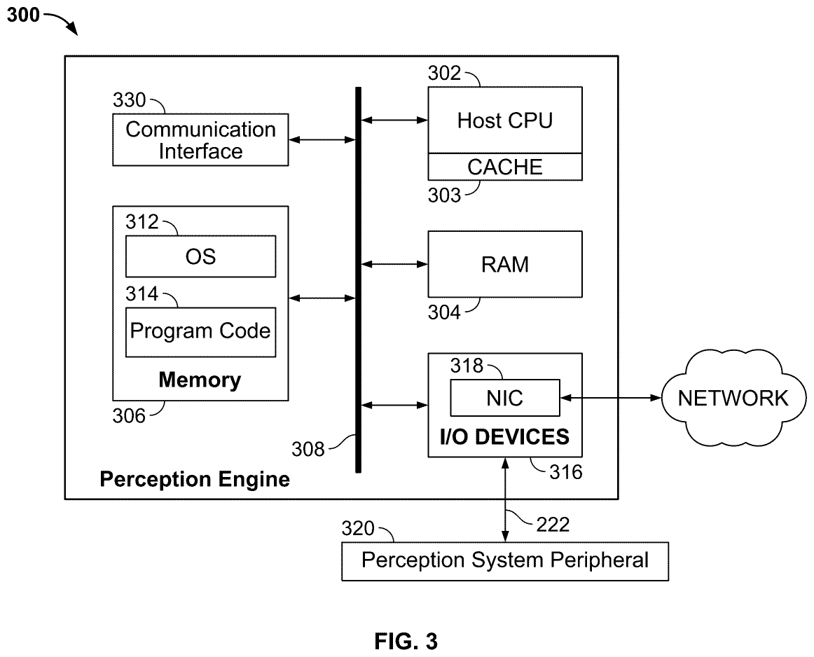

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

FIGS. 4-10 illustrate exemplary embodiments of fluid testing assemblies for use with a testing surface, such as a road 152. The fluid testing assemblies enable a fluid (e.g., a liquid, a gas, and combinations thereof) to be applied, removed, or applied and removed from the road 152 at various locations. The various locations along the road 152 may be predetermined and/or may be randomized. The fluid testing assemblies described herein provide repeatable testing environments for validating/verifying the performance of the vehicle 100 on the road 152. The fluid testing assemblies described herein may provide inputs to aid in characterizing the vehicle 100. Specific reference to a fluid is not intended to limit what material may be applied to the road 152 by the fluid testing assemblies, unless expressly stated otherwise. Thus, a solid may be applied to the road 152 in combination with, or separate from the fluid. It should be understood that like parts/features will be numbered the same throughout the various embodiments. The features described with respect to one embodiment may apply to the other embodiments unless expressly stated otherwise.

FIGS. 4 and 5 illustrate a fluid testing assembly 400 that is in fluid communication with the road 152. The fluid testing assembly 400 is configured to deliver a fluid (not shown) to at least a portion of the road 152. The fluid testing assembly 400 is configured to remove a fluid (not shown) from at least a portion of the road 152. The fluid testing assembly 400 includes a fluid container 402 that is in fluid communication with the road 152. The fluid container 402 includes at least one fluid (not shown) that is delivered to at least a portion of the road 152. Although depicted as a fluid container 402, it should be understood that the fluid may be delivered from a central depository or reservoir by a third party (e.g., a municipal supplier, a private supplier) to the road 152. The fluid container 402 may be refillable, removable, replaceable without departing from the spirit/scope of this disclosure.

A conduit (e.g., pipe, hose) 404 is connected to the fluid container 402 and is in fluid communication with the road 152. The conduit 404 includes an inlet 406, an outlet 408, and a flow passage 410 between the inlet 406 and outlet 408. The inlet 406 of the conduit 404 is connected to the fluid container 402 to receive the fluid (not shown) from the fluid container 402 into the flow passage 410 of the conduit 404. The outlet 408 of the conduit 404 is positioned in proximity to the road 152 to deliver the fluid from the flow passage 410 to a location on and/or near the road 152. The outlet 408 of the conduit 404 may be connected to and in fluid communication with a fluid distribution component (not shown). The fluid distribution component may include, but is not limited to, a nozzle, a coupling, a spray head, and variations thereof.

The fluid testing assembly 400 may include any number of conduits required to effectively deliver fluid to the road 152 to enable the performance of the autonomous vehicle to be assessed in the road conditions of interest. The fluid testing assembly 400 may include a second conduit 412 that is in fluid communication with the road 152. In some instances, the second conduit 412 may be in fluid communication with the conduit 404 and the road 152. For example, as shown in FIG. 4, the second conduit 412 is connected to the conduit 404 at a position along the flow passage 410. Fluid flowed through conduit 404 is selectively supplied to the second conduit 412 which in turn delivers the fluid to the road 152. The second conduit 412 delivers and/or removes a fluid from the road 152. The fluid of the second conduit 412 may be similar to or different from the fluid of the conduit 404. For example, the second conduit 412 may deliver water or a water mixture. The fluid of the second conduit 412 may be used to clean the road 152 from the fluid of the conduit 404.

The fluid testing assembly 400 may include a third conduit 414 that is in fluid communication with the road 152. In some instances, the third conduit 414 is in fluid communication with the conduit 404 and the road 152. For example, the third conduit 414 is connected to the conduit 404 at a position along the flow passage 410. For example, the third conduit 414 may remove the fluid from at least a portion of the road 152. The fluid may include the fluid delivered from the fluid container 402 to the road 152 and/or the water or water mixture delivered by the second conduit 412.

The fluid testing assembly 400 may include a controllable mechanism 416 in fluid communication with one or more of the first conduit 404, the second conduit 412, and the third conduit 414. The fluid testing assembly 400 may include a plurality of controllable mechanisms 416. The controllable mechanism 416 may include, but is not limited to, a valve, a pump, and variations and combinations thereof. The controllable mechanism 416 may be opened, closed, or partially opened depending on whether fluid is being delivered to or removed from the road 152. The controllable mechanism 416 may be a multi-directional mechanism to facilitate at least the delivery of and removal of fluid from the road 152. The controllable mechanism 416 may be a pump mechanism and may be configured to apply a positive pressure or a negative pressure to the fluid testing assembly 400.

In some instances, the controllable mechanism 416 may be positioned along the flow passage 410 of the conduit 404. As illustrated in FIG. 4, the controllable mechanism is in proximity to the outlet 408 of the conduit 404. Another controllable mechanism 416 may be positioned where the second conduit 412 connects with the conduit 404. The controllable mechanism 416 may be a multi-position mechanism (e.g., two-way, three-way, four-way, etc.). Another controllable mechanism 416 may be positioned where the third conduit 414 connects with the conduit 404. The controllable mechanism(s) 416 may selectively control the flow of the fluid, for example, in the direction of the road 152 and/or in the direction away from the road 152. As used herein, “controllable” may refer to manual and/or automated control of the mechanism or mechanisms 416.

The road 152 defines a driving surface 154 wherein at least a portion of the vehicle 100 (e.g., the wheels) is in contact with. Below the driving surface 154 may be one or more layers of material, including but not limited to, aggregate, stone, dirt, concrete, asphalt, and combinations/variations thereof. The road 152 may be layered or a single material. Referring to FIG. 4, the road 152 includes one or more depressions 156 (e.g., pothole) that extend in a direction away from the driving surface 154 of the road 152. The depression 156 defines a depression surface 158 that is spaced a distance from the driving surface 154 to create a void 160 between the driving surface 154 and the depression surface 158. Unless expressly stated otherwise, the driving surface 154 may also include the depression surface 158. Thus, at least a portion of the vehicle 100 may be in contact with the driving surface 154, the depression surface 158, or the driving surface 154 and the depression surface 158. The cross-section of the depression 156 may be a symmetrical or asymmetrical shape. The periphery of the depression 156 may be a regular or irregular shape, as illustrated in FIG. 5.

Referring to FIG. 5, the depressions 156 may be located at any position relative to and along the driving surface 154. For example, the depression(s) 156 may be positioned in closer proximity to a first side of the road 162 than a second side of the road 164. Alternatively, the depression(s) 156 may be positioned in closer proximity to the second side of the road 164 than the first side of the road 162. In some embodiments, a plurality of depressions are positioned in closer proximity to the first side of the road 162 and a plurality of depressions are positioned in closer proximity to the second side of the road 164.

One or more of the conduits 404, 412, 414 are in fluid communication with the depression 156 along the road 152. If more than one depression is provided along the road, one or more of the conduits are configured to deliver fluid to each of the depressions 156. One or more of the conduits 404, 412, 414 are configured to deliver the fluid to the depression 156 and/or configured to remove the fluid from the depression 156. For example, the conduit 404 is connected with and in fluid communication with the depression 156. The conduit 404 is configured to deliver the fluid to

In operation, fluid is delivered to the depression 156 from the fluid container 402 through the fluid passage 410 of the conduit 404. The depression 156 may be at least partially filled with the fluid. In some instances, the depression 156 is filled entirely with the fluid such that the fluid spills onto at least a portion of the driving surface 154 of the road 152. The fluid container 402 may at least partially fill at least one depression 156. In some instances, the fluid container 402 may at least partially fill a plurality of depressions 156. The fluid within the depression 156 may be drained using at least a portion of conduit 404. The fluid may be discharged from the conduit 404 through the third conduit 414. Water or a water solution may be introduced into the depression 156 through at least the second conduit 412. The water or water solution is introduced into the depression 156 through the second conduit 412 and the conduit 404. The water or water solution may flush the fluid or the remainder thereof from the depression 156. The controllable mechanism 416 may coordinate the delivery and/or removal of a fluid from the depression 156. When the fluid is supplied to the depression, the controllable mechanism 416 associated with the fluid supply conduit 404 and/or 412 and/or 414 functions to permit fluid to flow through the conduit. Once the fluid has been supplied to the depression, the controllable mechanism is controlled to impede the flow of fluid from the depression, through the conduit and back to the fluid container 402.

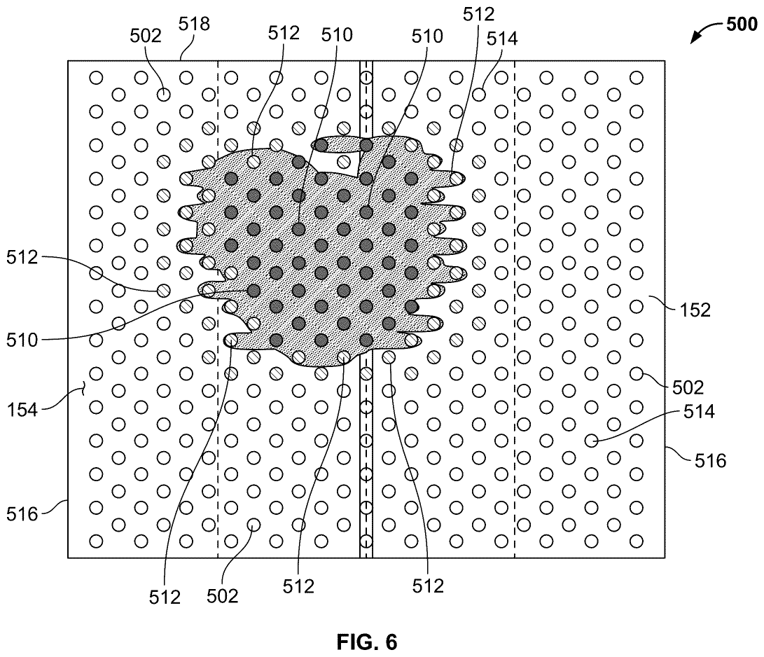

Referring to FIGS. 6-8, a second embodiment describes a fluid testing assembly 500. The fluid testing assembly 500 includes a plurality of openings 502 positioned relative to the driving surface 154 of the road 152. The plurality of openings 502 may be positioned relative to the driving surface 154 where openings may or may not be separated from adjacent openings by a similar magnitude distance and/or may be positioned in a grid-like pattern. The plurality of openings 502 may be positioned in selected areas of the road 152 or along the entirety of the road 152. The plurality of openings 502 may be positioned along the driving surface 154, below the driving surface 154 (e.g., within the depression 156), above the driving surface 154, or combinations thereof.

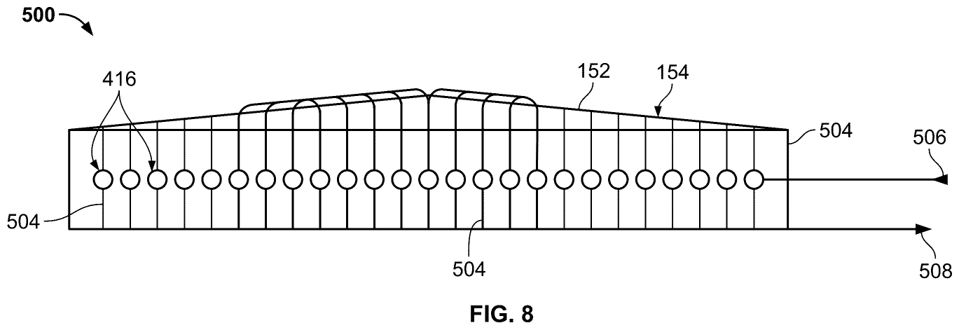

The fluid testing assembly 500 includes a conduit 504 that is in fluid communication with at least one of the plurality of openings 502. Referring to FIG. 8, the fluid testing assembly 500 includes a conduit 504 that is in fluid communication with the plurality of openings 502. The plurality of openings 502 may be connected to the conduit 504 either directly or indirectly. The plurality of openings 502 may be indirectly connected to the conduit 504 such that one or more additional components (not shown) may be connected between the plurality of openings 502 and the conduit 504. The one or more additional components (not shown) may include a pump, a sensor, a gauge, a coupling, and combinations and variations thereof. The conduit 504 may be a single conduit or may be a network of conduits and each may be used interchangeably without departing from the spirit/scope of this disclosure, unless expressly stated otherwise.

The network of conduits 504 includes an inlet 506 and an outlet 508. The inlet 506 and the outlet 508 of the network of conduits 504 may be the same opening or may be different openings. The network of conduits 504 are connected to one or more controllable mechanisms 416. The one or more controllable mechanisms 416 may deliver and/or remove a fluid from the road 152 based on a desired test plan. The openings 502 may be sized and shaped to deliver and/or remove the fluid to/from the driving surface in a desired period of time. For example, the openings 502 may be circular and have a diameter between about 0.03 inches to about 0.5 inches.

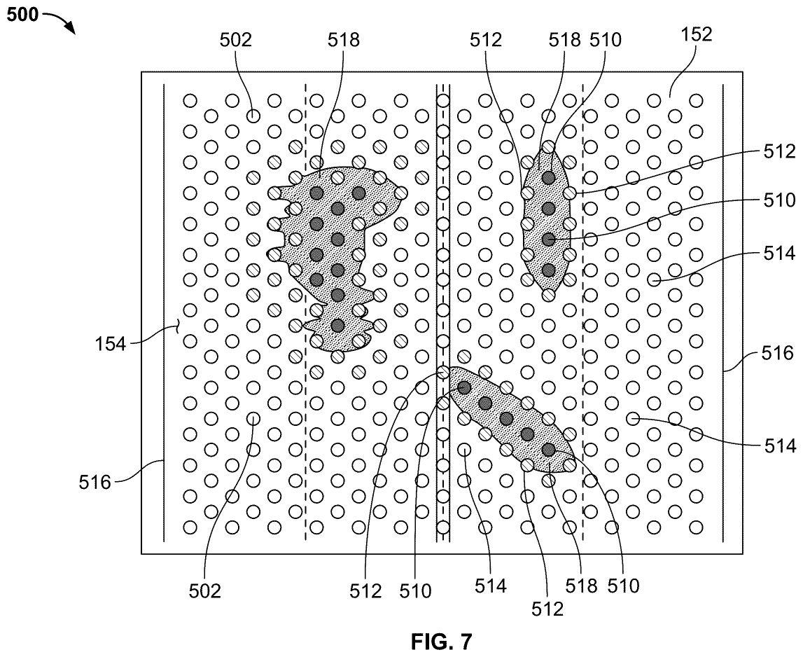

The plurality of openings 502 are in fluid communication with a source(s) of fluid to deliver a fluid to the driving surface 154 of the road 152. For example, the source of fluid may be the fluid container 402 of the fluid testing assembly 400. The fluid testing assembly 500 may be selectively operated to deliver fluid to the road 152 through a selected opening or selected group of openings 502 of the plurality of openings 502. The fluid testing assembly 500 may be selectively operated to remove or drain the fluid the road 152 through a selected opening or selected group of openings 502 of the plurality of openings 502. By delivering and draining water, fluid stays roughly in the desired location relative to the driving surface 154 of the road 152 (FIGS. 6 and 7).

The plurality of openings 502 may be further identified as an opening or a plurality of openings that deliver a fluid to the road 152, an opening or a plurality of openings that remove a fluid from the road 152, and an opening or a plurality of openings that are inactive, meaning they neither deliver nor remove a fluid to/from the road 152. Referring to FIGS. 6 and 7, the plurality of openings 502 that are delivering the fluid are identified as reference number 510, the plurality of openings 502 that are removing the fluid are identified as reference number 512, and the plurality of openings 502 that are inactive are identified as reference number 514. The delivering openings 510, the removing openings 512, and the inactive openings 514 may be collectively referred to as reference number 502. Distinguishing among the three opening states(delivering, removing and inactive openings) enables a more thorough explanation of the fluid testing assembly 500. Distinguishing between openings as delivering, removing and inactive does not, however, inherently reflect differences between the plurality of openings 502, unless otherwise expressly stated. Each of the plurality of openings 502 may, at various instances, be classified as the delivery opening 510, the removing opening 512, and the inactive opening 514.

The fluid testing assembly 500 may include a channel 516 that is positioned relative to the road 152. The channel 516 may be positioned to capture fluid from at least the driving surface 154 of the road 152. For example, the channel 516 may be positioned at one or both sides of the road 152, as depicted in FIGS. 6 and 7. The channel 516 may be in fluid communication with the conduit 504.

In operation, the fluid testing assembly 500 is configured to deliver the fluid to a desired location along the driving surface 154 of the road 152. The plurality of openings 502 may be normally open so as to allow the fluid to be delivered to the road 152 or to be removed from the road 152. The controllable mechanism 416 may be controlled to enable delivery of the fluid to the driving surface 154 of the road 152 through the one or more conduits 504 in fluid communication with the controllable mechanism 415. When the controllable mechanism is controlled to enable fluid delivery, the fluid is delivered to a desired location of the road 152 (FIGS. 6 and 7) through delivery openings 510 of the plurality of openings 502. The size and shape and location or extent of a fluid pool 518 is determined by the volume of fluid dispensed by the delivery openings 510, the location and/or the quantity of the discharge openings 512, and/or the characteristics of the driving surface 154 of the road 152. For example, the delivery openings 510 are identified from the plurality of openings 502 based, in part, on the desired location of the fluid pool 518. This may include activating the controllable mechanism(s) 416 associated with the identified delivery openings 510 to deliver the fluid to the driving surface 154. The discharge openings 512 are identified from the plurality of openings 502 based, in part, on the desired location where there will be reduced or no fluid. This may include activating the controllable mechanism(s) 416 associated with the identified discharge openings 512 to remove the fluid from the driving surface 154. Unused openings may remain as inactive openings 514, which may include deactivating or not activating one or more of the plurality of openings 502 by deactivating the controllable mechanism.

The fluid testing assembly 500 is customizable based on the desired testing configuration of the vehicle 100. The desired testing configuration may include, for example, the location of the fluid pool 518 relative to the driving surface 154, the size of the fluid pool 518, the location of the fluid pool 518 relative to the area where the vehicle 100 will travel, the shape of the fluid pool 518, and combinations and variations thereof. In a non-limiting example, the testing may include how the vehicle 100 travels through the entirety of the fluid pool 518, a portion of the fluid pool 518, and/or how the vehicle 100 avoids the fluid pool 518. The amount of the fluid in the fluid pool 518 may vary based on the desired testing configuration, for example, a coating where the driving surface 154 is merely wet with the fluid to an inch or so of the fluid to several feet of the fluid. The fluid testing assembly 500 may include one fluid pool 518, as depicted in FIG. 6, or two or more fluid pools 518, as depicted in FIG. 7.

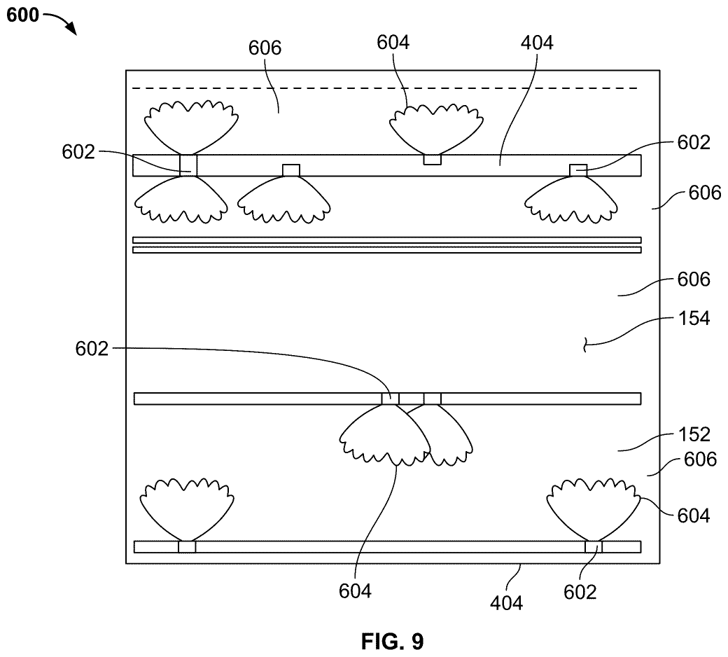

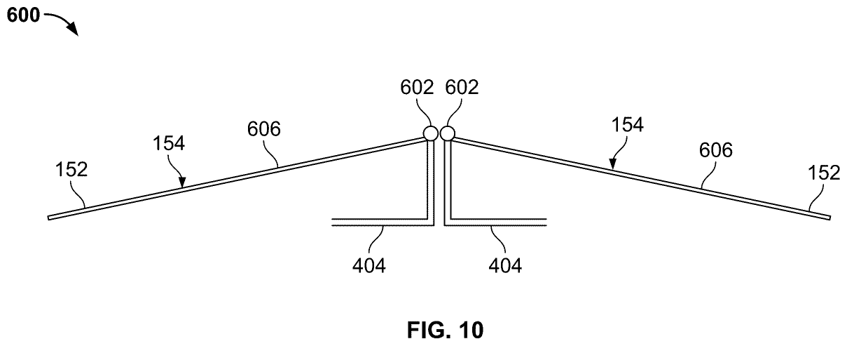

In another embodiment, referring to FIGS. 9 and 10, a fluid testing assembly 600 includes a fluid delivery device 602 that is in fluid communication with a source(s) of fluid to deliver a fluid to the driving surface 154 of the road 152. For example, the source of fluid may be the fluid container 402 of the fluid testing assembly 400 (FIG. 4). The fluid container 402 may be connected to the fluid delivery device 602 by the conduit 404, as described with reference to the fluid testing assembly 400. The fluid may be delivered to the fluid delivery device 602 by gravity, a pump, or gravity and a pump. The fluid delivery device 602 is positioned in proximity to the driving surface 154 of the road 152. The fluid delivery device 602 is configured to deliver the fluid to the driving surface 154 at a desired location along the road 152. The fluid delivery device 602 may be positioned on the driving surface 154 such that the vehicle 100 travels over and/or alongside the fluid delivery device(s) 602. The fluid delivery device 602 may be a spray nozzle, a coupling, and variations thereof.

Referring to FIG. 9, the fluid delivery device 602 may be positioned at various locations on either side of the double line. The fluid delivery device 602 may be positioned to direct the fluid 604 in a desired direction along the driving surface 154. For example, directing the fluid 604 to a specific location of a driving lane 606 of the road 152. The fluid delivery device 602 may be oppositely positioned from another fluid delivery device 602. The opposing fluid delivery devices 602 may direct fluid to different sides and/or locations of the driving lane 606, as shown in FIG. 9. The fluid delivery device 602 may provide the fluid 604 to the driving surface 154, as shown in FIG. 9. Alternatively, the fluid delivery device 602 may redirect fluid provided to or sitting on the driving surface 154.

Referring to FIG. 10, the fluid delivery device 602 may be positioned in proximity to the center of the road 152. In some instances, two or more fluid delivery devices 602 may be positioned in proximity to the center of the road 152. For example, one or more fluid delivery devices 602 may be directed in a first direction and one or more fluid delivery devices 602 may be directed in a second direction. The road 152 may be pitched away from the fluid delivery device 602 such that fluid is directed across the driving lane 606 and in a direction away from the fluid delivery device 602. Existing roads oftentimes include a pitch away from the center of the road 152 to direct water away from the driving lanes 606. Although depicted with the road 152 being pitched, it should be understood that the road 152 may be level or pitched in a different direction.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A fluid testing assembly configured for use with a road, the fluid testing assembly comprising:
a fluid source containing a fluid, wherein the fluid source is connected to a conduit and in fluid communication with a driving surface of the road;
the conduit defines an outlet positioned in proximity to the driving surface of the road,
wherein the fluid is delivered from the fluid source to a desired location along the driving surface through the outlet of the conduit.

2. The fluid testing assembly according to claim 1, wherein the desired location along the driving surface is a depression, wherein at least a portion of the fluid is delivered to fill the depression.

3. The fluid testing assembly according to claim 2, wherein the outlet of the conduit is positioned at a location within the depression.

4. The fluid testing assembly according to claim 1 further comprising a discharge conduit in fluid communication with the driving surface, the discharge conduit configured to remove the fluid from the driving surface.

5. The fluid testing assembly according to claim 1 further comprising a plurality of openings extending through the driving surface, the plurality of openings are in fluid communication with the conduit and are each selectively configured to deliver the fluid to the driving surface or remove the fluid from the driving surface.

6. The fluid testing assembly according to claim 5, wherein the plurality of openings are positioned in a grid-like configuration.

7. The fluid testing assembly according to claim 5, wherein the desired location of the fluid along the driving surface is configured based on selectively activating a first subset of the plurality of openings to deliver the fluid to the desired location.

8. The fluid testing assembly according to claim 7, wherein the desired location of the fluid is defined by selectively activating a second subset of the plurality of openings positioned around the periphery of the first subset of the plurality of openings to discharge the fluid and define at least a portion of the shape at the desired location.

9. The fluid testing assembly according to claim 5, wherein each of the plurality of openings are in further communication with a discharge conduit, the discharge conduit configured to remove the fluid from the driving surface.

10. The fluid testing assembly according to claim 1 further comprising a spray nozzle connected to the outlet of the conduit.

11. A method of distributing a fluid to a driving surface of a road for testing a vehicle, the method comprising:
directing the fluid from a fluid source to the driving surface of the road;
controlling the distribution of the fluid to the driving surface at a desired location; and
discharging the fluid from the driving surface.

12. The method according to claim 11, wherein the fluid is directed to the desired location along the driving surface through a plurality of openings, the method further comprising:
activating a first subset of the plurality of openings to deliver the fluid to the desired location; and
activating a second subset of the plurality of openings to discharge the fluid from the periphery of the desired location.

13. The method according to claim 11, wherein the desired location is a depression, and wherein at least a portion of the fluid is delivered to fill the depression.

14. The method according to claim 12, wherein the first subset and the second subset are selectively configured to deliver the fluid or discharge the fluid.

15. A fluid testing assembly configured for use with a road, the fluid testing assembly comprising:
a fluid source containing a fluid, wherein the fluid source is connected to a plurality of openings and in fluid communication with a driving surface of the road; and
the plurality of openings extend through the driving surface of the road and are each selectively configured to deliver the fluid to the driving surface or remove the fluid from the driving surface.

16. The fluid testing assembly according to claim 15, wherein the plurality of openings are positioned in a grid-like configuration.

17. The fluid testing assembly according to claim 15, wherein the desired location of the fluid along the driving surface is configured based on selectively activating a first subset of the plurality of openings to deliver the fluid to the desired location.

18. The fluid testing assembly according to claim 17, wherein the desired location of the fluid is defined by selectively activating a second subset of the plurality of openings positioned around the periphery of the first subset of the plurality of openings to discharge the fluid and define at least a portion of the shape at the desired location.

19. The fluid testing assembly according to claim 15, wherein each of the plurality of openings are in further communication with a discharge conduit, the discharge conduit configured to remove the fluid from the driving surface.

20. The fluid testing assembly according to claim 15, wherein a first subset of the plurality of openings is selected to deliver the fluid to the desired location, wherein a second subset of the plurality of openings is selected to discharge the fluid from the periphery of the desired location, wherein the first subset and the second subset are interchangeable therewith.
